(19) United States
(12) Patent Application Publication
(10) Pub. No.: US 2011/0168459 A1
(43) Pub. Date: Jul. 14, 2011

(54) Mobile Kinetic Wind Generator System

(75) Inventor: Brian Benjamin Ganner, Fountain Inn, SC (US)

(73) Assignee: FORTUNE ONE, LLC, Fountain Inn, SC (US)

(21) Appl. No.: 12/986,870

(22) Filed: Jan. 7, 2011

Related U.S. Application Data
(60) Provisional application No. 61/293,370, filed on Jan. 8, 2010.

(51) Int. Cl. B60L 8/00

(52) U.S. Cl. 180/2.2

(57) ABSTRACT

An electrical power generation system that supplies electrical power to a vehicle is described herein. Rotational energy for the generator is provided by a motor having a paddle assembly. The forward or reverse motion of a vehicle having the presently disclosed system installed causes air to move through the paddle assembly. The moving air imparts a force upon the paddles that causes the paddles to rotate. The paddle assembly is in mechanical communication with the generator. Thus, the rotation of the motor is translated to rotation of the generator, providing for electrical power generation. The generation may be used to supply the electrical needs of various systems on the vehicle, as well as charging of the battery.

### CROSS-REFERENCE TO RELATED APPLICATION

This application claims priority under 35 U.S.C §119(e) to U.S. provisional application Ser. No. 61/293,370, filed on Jan. 8, 2010, entitled “Mobile Kinetic Wind Generator System,” which is herein incorporated by reference in its entirety.

### TECHNICAL FIELD

The presently disclosed subject matter is generally related to electrical power generation systems in vehicles.

### BACKGROUND

There are various ways in which electrical power may be provided to electrical systems in vehicles. For example, electrical power may come from a battery mounted in the vehicle. In another example, electrical power may come from a generator system.

### SUMMARY

The present subject matter is directed to electrical power generation through the use of an electrical charging motor, which may be termed an air inertia motor. The air inertia motor utilizes a fan blade assembly, or paddles, in mechanical communication with a generator. When the motor is placed in the path of a moving air current, the moving air current causes the paddles to spin or rotate. The spinning, or rotational, motion is translated via a gear or other assembly to a rotor of a generator; thus, creating electrical power. The forward or reverse motion of the vehicle creates the moving air current.

In some embodiments of the presently disclosed subject matter, a starter may be provided to provide initial rotation to the motor. The starter may rotate the motor according to various requirements, such as electrical loading and vehicle speed.

In some embodiments of the presently disclosed subject matter, the electrical power provided by the motor may be used to augment or supplement the electrical power provided by other sources, such as the battery, or batteries, of a vehicle.

These and other features of the subject matter are described below.

### BRIEF DESCRIPTION OF THE DRAWINGS

The foregoing summary, as well as the following detailed description of the subject matter is better understood when read in conjunction with the appended drawings. For the purposes of illustration, there is shown in the drawings exemplary embodiments; however, these embodiments are not limited to the specific methods and instrumentalities disclosed. In the drawings:

FIG. 1 is an exemplary illustration of an air inertia motor using a gear system to translate rotational motion of the air inertia motor to a generator;

FIG. 2 is an exemplary illustration of an air inertia motor using an alternate means of translating rotational motion of the air inertia motor to a generator;

FIGS. 3 and 4 are exemplary illustrations of an air inertia motor using an ignition/starter along with exemplary motor bearings;

FIG. 4 is an exemplary illustration of an air inertia motor using an ignition/starter;

FIGS. 5 and 6 are exemplary illustrations of an air inertia motor using a gear system to translate rotational motion of the air inertia motor to a generator along with exemplary motor bearings;

FIG. 7 is an exemplary status indicator;

FIG. 8 is an exemplary illustration of an air inertia motor using a flywheel;

FIGS. 9 and 10 are front views of exemplary illustrations of an air inertia motor;

FIGS. 11 and 12 are exemplary illustrations of an air inertia motor using a gearing or transmission assembly;

FIG. 13 an exemplary illustration of an air inertia motor ignition/starter;

FIG. 14 is an exemplary illustration showing air flow over the paddle assembly;

FIG. 15 is an exemplary illustration of a control box for an air inertia motor;

FIG. 16 is an exemplary control panel;

FIG. 17 illustrates an exemplary grounding device;

FIG. 18 is an exemplary locking device; and

FIG. 19 is an exemplary illustration of a preferred embodiment of an air inertia motor.

### DETAILED DESCRIPTION OF ILLUSTRATIVE EMBODIMENTS

Certain specific details are set forth in the following description and figures to provide a thorough understanding of various embodiments of the subject matter. Certain well-known details are not set forth in the following disclosure to avoid unnecessarily obscuring the various embodiments of the subject matter. Further, those of ordinary skill in the relevant art will understand that they can practice other embodiments of the subject matter without one or more of the details described below. Finally, while various methods may be described with reference to steps and sequences in the following disclosure, the description as such is for providing a clear implementation of embodiments of the subject matter, and the steps and sequences of steps should not be taken as required to practice this subject matter.

An air inertia motor is disclosed that rotates a generator to supply electrical power to a vehicle, either to supplant or supplement other electrical power sources available in the vehicle, such as a battery. The air inertia motor achieves a rotating motion through the use of directed air imparting force onto a paddle (or fan blade) assembly. The moving air rotates the paddles, which in turn rotate a generator to cause the creation of electrical energy. The generator may be of various types, but for use in an automobile, the generator used is preferably a direct current generator. The directed air is produced by the forward or reverse motion of the vehicle. In some examples, it may be preferable to have the motor spinning prior to use. In those examples, a starter/ignition system may be used to impart a rotating force on the air inertia motor. Various means of generating the rotating starting force may be used including, but not limited to, the rotation or other kinetic output of a gasoline engine or an electrical starter motor.

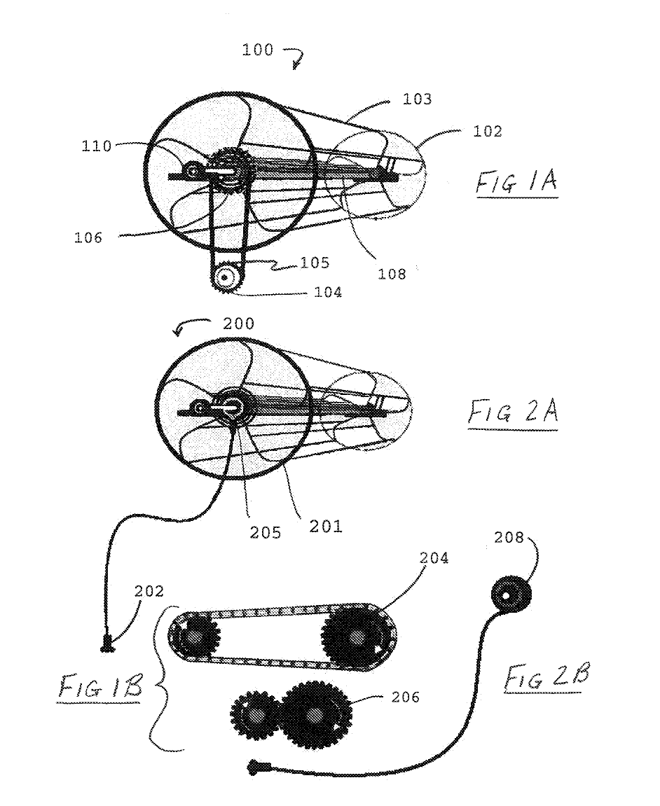

Turning now to the figures, FIG. 1 is illustrative of a system for generating electrical power in a vehicle. System 100 has paddle assembly 102 which comprises fans 103 that extend a distance. As wind enters paddle assembly 102, the energy of the wind imparted on fans 103 causes paddle assembly 102 to rotate about axis 108. The rotation of paddle assembly 102 is transferred to a rotational motion on a generator (not shown) through gears 106 and 104 connected via belt 105. It should be noted that various shapes, contours or other design factors may be utilized for the paddle assembly 102 based upon various factors such as expected load conditions, average speed of the vehicle, and the like. The present subject matter is not limited to any particular configuration.

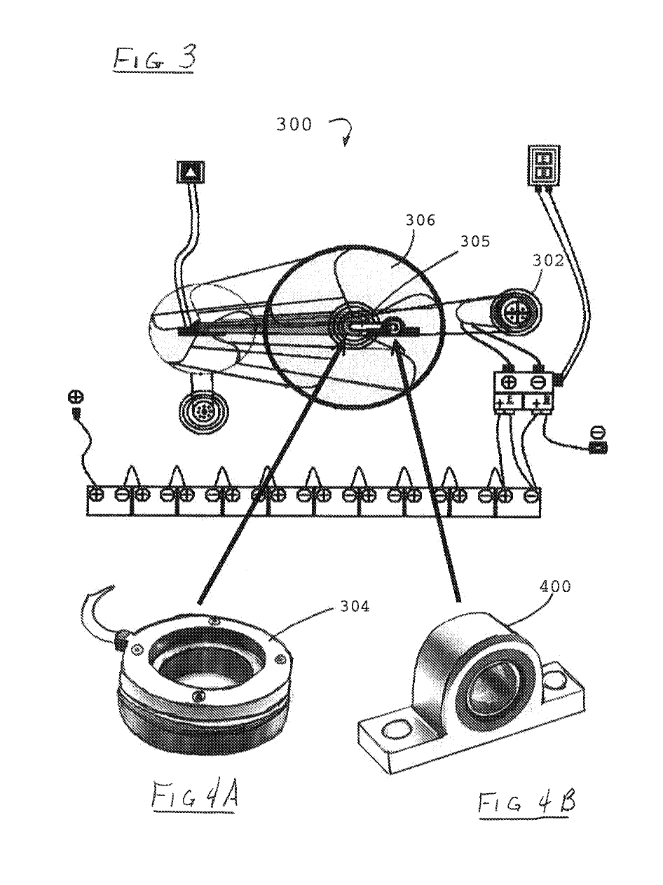

In some configurations, it may be beneficial to initially rotate paddle assembly 102, especially when a vehicle having paddle assembly 102 installed is at or near idle speed. FIG. 2 shows various and exemplary ways in which rotational motion may be imparted on a paddle assembly without the need for or in addition to any available wind energy. In one example, system 200 having paddle assembly 201 has installed thereon bearing 205. Bearing 205 has an internal drive assembly which is turned by cable assembly 202. Cable assembly 202 has an internal cable (not shown) that rotates, the rotational motion of which is translated through an internal gearing mechanism (not shown) associated with bearing 205 to rotate paddle assembly 201. Cable assembly 208 is an exemplary illustration of the cable assembly when detached from paddle assembly 201. Once a vehicle has initiated motion, or for any other reason in which it is desired to rotate paddle assembly 201, cable assembly 202 is engaged and begins the rotation of paddle assembly 201. Once the vehicle has achieved a predetermined, selected, or ascertained speed, or the paddle assembly 201 has achieved a certain velocity, or as other conditions or combination of conditions may warrant, cable assembly 202 is disengaged and the rotation of paddle assembly 201 is provided by the movement of air through paddle assembly 201.

In another example, gear assembly 204 may be used. Gear assembly 204 has two gears connected via a chain. When one gear rotates, the other gear, which is connected to paddle assembly 201, rotates. In another example, direct drive 206 may be used, which is a modification of a gear assembly, like gear assembly 204, but with the need for a chain removed because of the direct interaction with the gears.

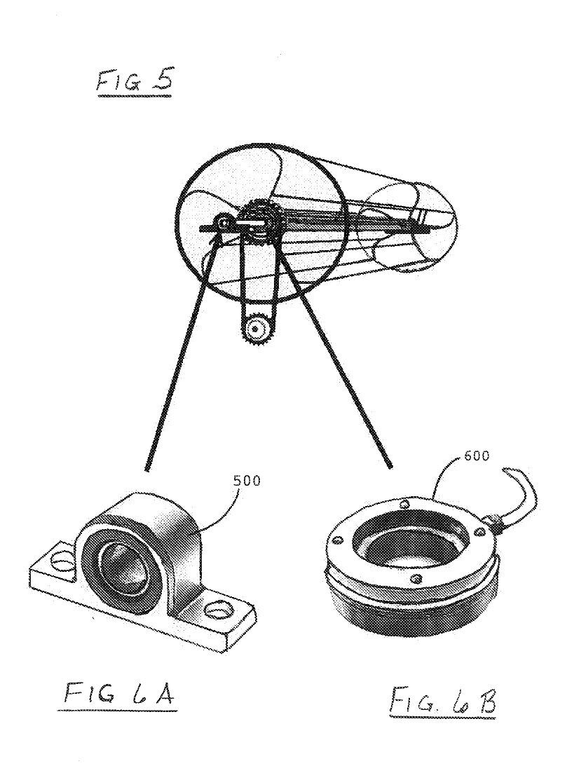

Shown in FIG. 3 is an exemplary bearing, bearing 304, that may be used to rotate a paddle assembly, such as assembly 201 of FIG. 2 associated with a generator (not shown). Bearing 304 may be connected to a cable assembly, such as cable assembly 202 of FIG. 2. In some configurations, bearing 304 may also have an integrated sensor (not shown). Various sensors may be used to provide for a variety of monitoring capabilities. For example, because paddle assembly 306 is expected to rotate, it may be beneficial to monitor paddle assembly 306 for vibration or seizure. Thus, bearing 304 may have an integrated vibration and/or seizure sensor. Further, it may also be beneficial to have a backup bearing, such as bearing 400, in case the main bearing, bearing 304, fails.

Also shown is generator 302 connected to an electrical system. Generator 302 may be configured to provide power to the electrical system in various manners. Further, generator 302 may be configured to generate power in various ways. For example, generator 302 may be connected to the electrical system to act as the main power source for a drive system (not shown) or to recharge onboard batteries (not shown) or both. The stator (not shown) of generator 302 may be coupled to a pulse generator controlled by a pulse width modulator. Instead of maintaining power to the windings of the stator, and, thus, always creating power, the stator of generator 302 may be pulsed with various voltages; thus, manipulating its duty cycle. In that manner, paddle assembly 306 may act essentially as a capacitor storing energy for use. This provides various benefits such as controlling the power output for a given speed and reducing the electrical drag on the paddle assembly 306; thus, minimizing the reduction of the inertia or rotation of the motor while maximizing power output and efficiency for various load and speed conditions.

FIG. 4 is illustrative of a bearing that may be used to support system 300 of FIG. 3. Support rod 305, which preferably extends at least partially through paddle assembly 306 of FIG. 3, may be supported by bearing 400 (a duplicate of which may be used on the distal end of support rod 305 to support the other side of paddle assembly 306).

FIGS. 5 and 6 illustrate three exemplary means of either providing rotational support or translating rotation of a paddle assembly to a generator. Shown are bearing 500 which provides support to a rod assembly and bearing 600 which not only provides rotational support, but also translates rotational motion from a cable assembly.

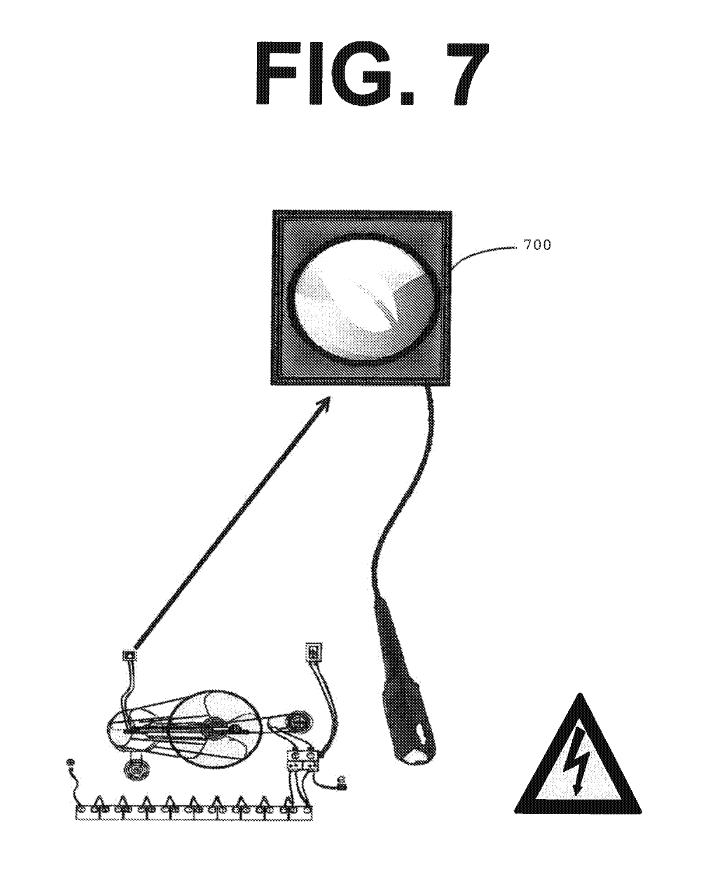

The operator of a vehicle having a system of the presently disclosed subject matter installed may wish or need to monitor the system to determine its operational status. An exemplary indicator is shown in FIG. 7. Indicator 700 is a dash mounted indicator that monitors and displays the status of a system of the presently disclosed subject matter. In one embodiment, a flashing green leaf may be used to show that the system is working properly. In another exemplary embodiment, the green leaf of FIG. 7 may switch colors, such as red, or stay on if a failure or system degradation occurs; thus, prompting the user to have the system checked or otherwise inspected.

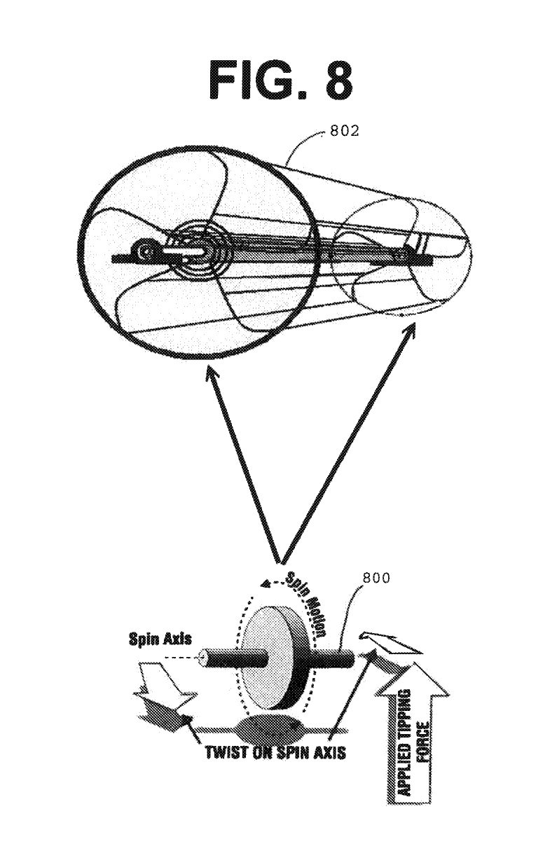

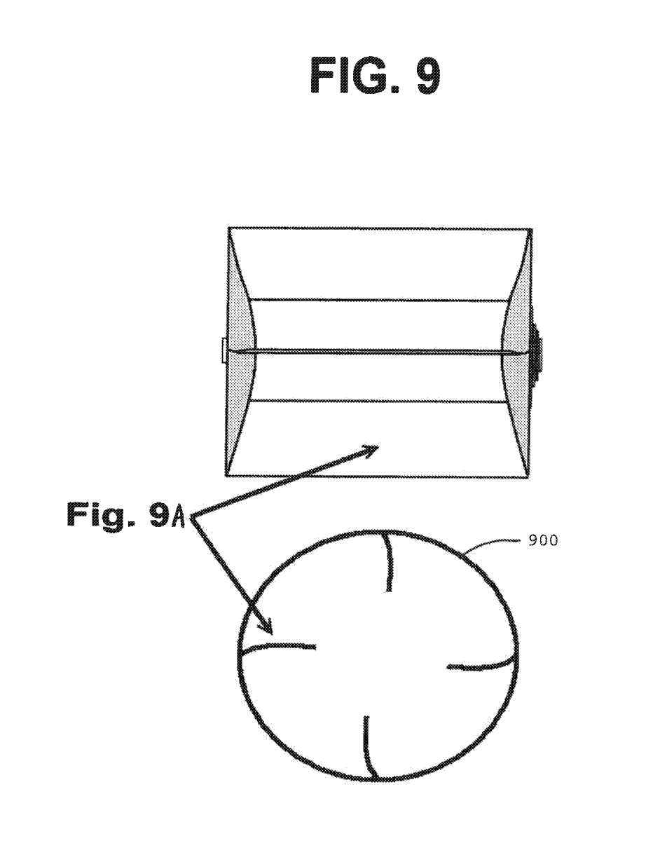

FIG. 8 shows a flywheel that may be used to stabilize and maintain the rotation of a paddle assembly. Because a vehicle is expected to have various speeds, including no forward or reverse velocity at all, the rotation of the paddle assembly may not have the consistency to provide electrical power to various electrical loads when the speed varies. Thus, to reduce the variance, flywheel 800 may be used. Flywheel 800 may be connected to system 802 in various ways known in the art, but acts to provide a makeup source of rotational energy when slowing down, i.e. when the air flow velocity decreases, or to reduce the magnitude of a spike increase in electrical power if the vehicle suddenly increases speed. The weight of flywheel 800 may be adjusted based upon the expected performance and use criteria of the vehicle. Additionally, flywheel 800 may be detachable from system 802, either automatically or manually, to change the performance characteristics of system 802.

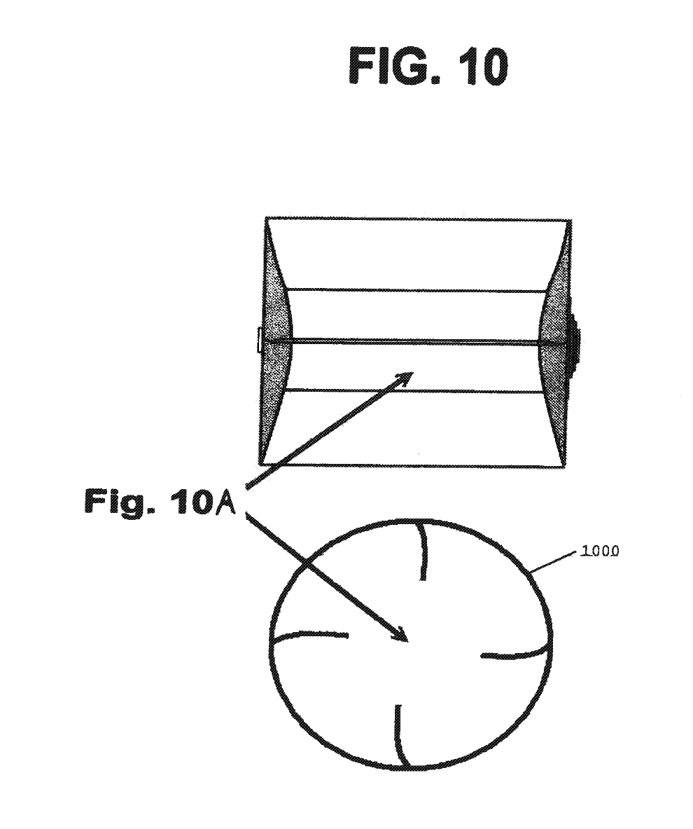

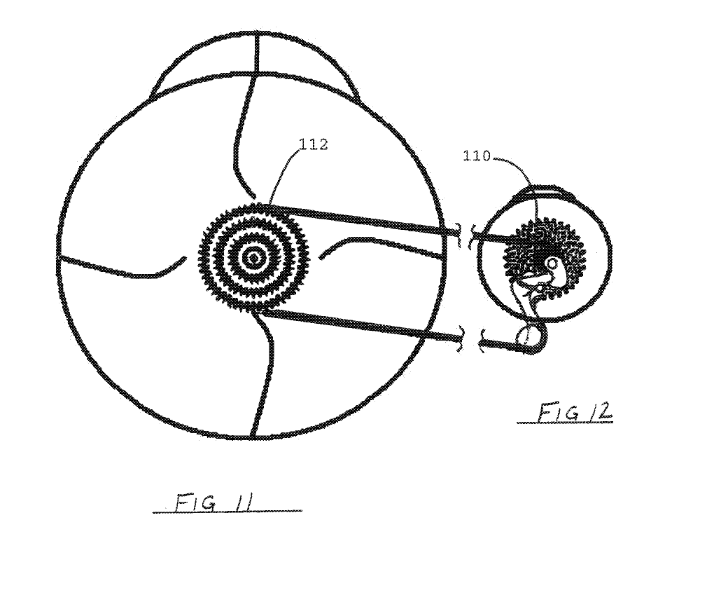

FIGS. 9 and 10 are front views of paddle assemblies 900 and 1000, respectively. In FIG. 9, the arrows are pointing toward the fans of paddle assembly 900 onto which the air primarily imparts force, and, in FIG. 10, the arrows are pointing to a void space which allows the flow of air through the paddle assembly.

FIGS. 11 and 12 show an alternate means of translating the rotational force to a generator. Shown are gear assembly 112 and gear assembly 110. The combination of gear assemblies 112 and 110 may be likened to a bicycle gear assembly in which multiple gears provides various gear ratios. In other words, gear assembly combination of 112 and 110 may act as one form of a continuously variable transmission (“CVT”).

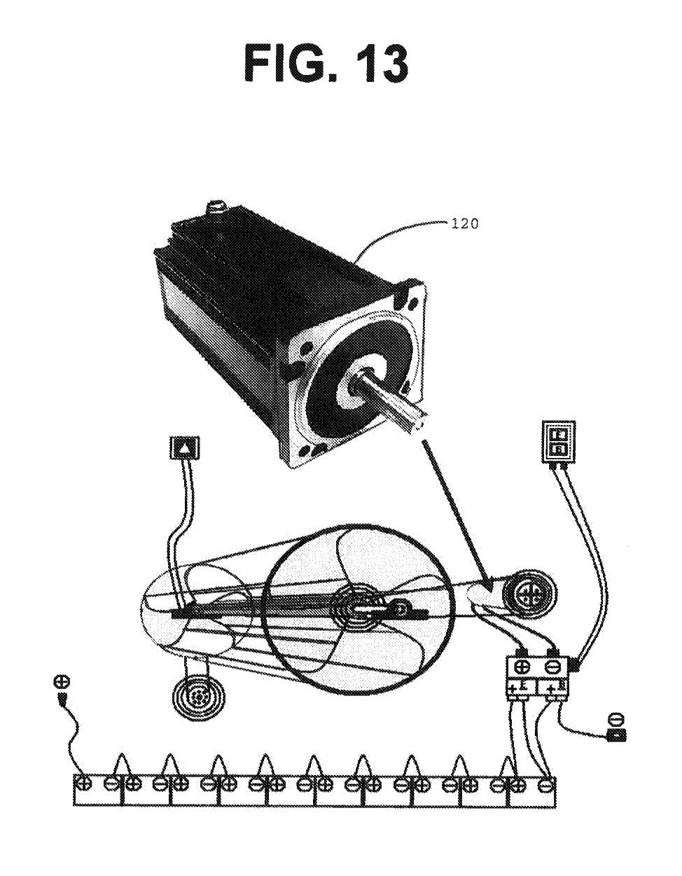

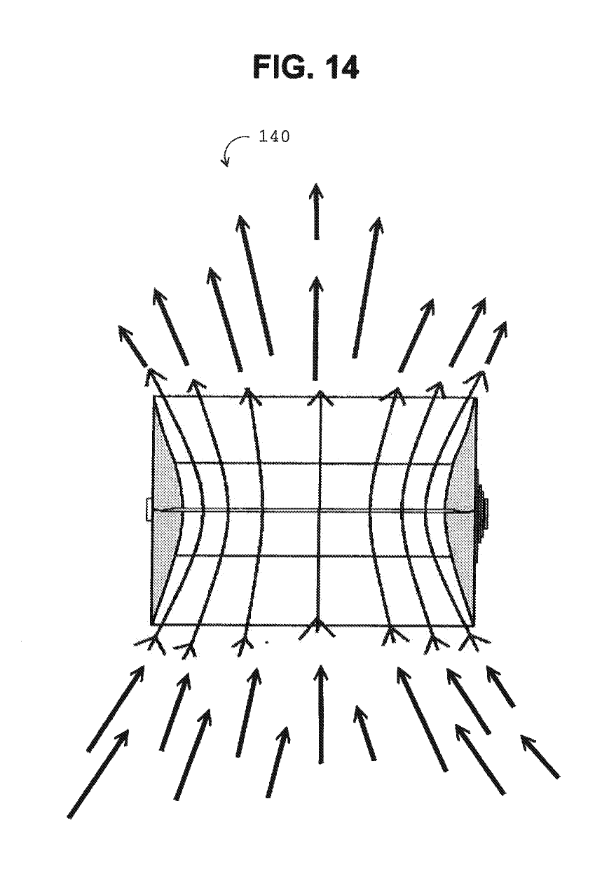

FIG. 13 is a front view of a generator, generator 120, which may be used to generate electrical power. In this configuration, the rotor of generator 120 is connected directly to the paddle assembly and an electrical system.

FIG. 14 is an illustrative view of how air may move through the assembly.

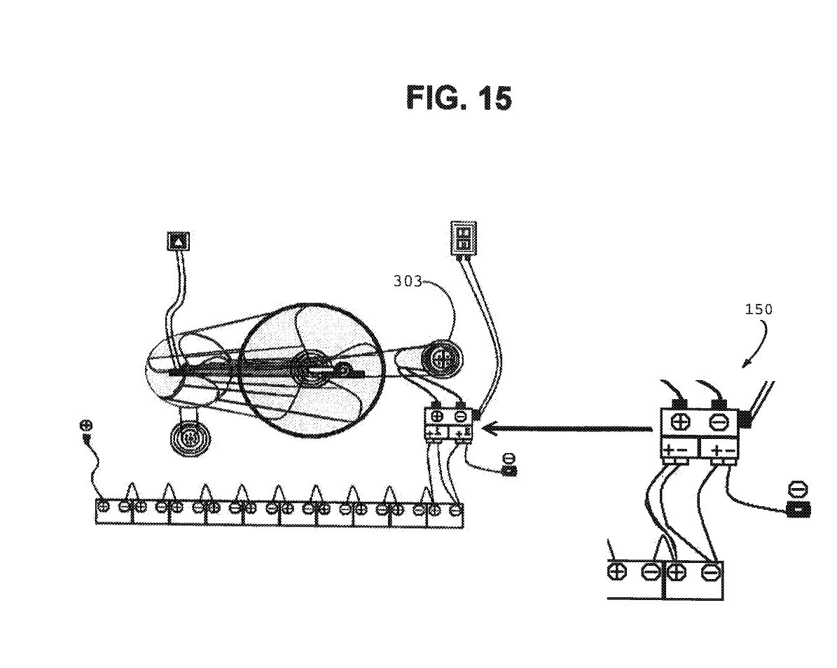

FIG. 15 is an illustrative view of an exemplary control board that may be used to control electrical power generation and distribution. The energy produced from generator 303 passed to control board 150, which may be, or may be associated with, an onboard computer. Control board 150 is wired to one or more batteries and/or a propulsion system in either a parallel or series configuration depending upon the electrical load or performance requirements. For example, the system may operate in two different manners, economy and boost. If boost “B” is selected, the output of generator 303 may be connected to the electrical system in a series configuration. If economy “E” is selected, the output of generator 303 may be connected to the electrical system in a parallel configuration, which may provide recharging capabilities for any onboard electrical storage systems such as a battery, or which may act to reduce the electrical load upon the battery or batteries. Control Board 150 may be controlled manually or by computer, or both.

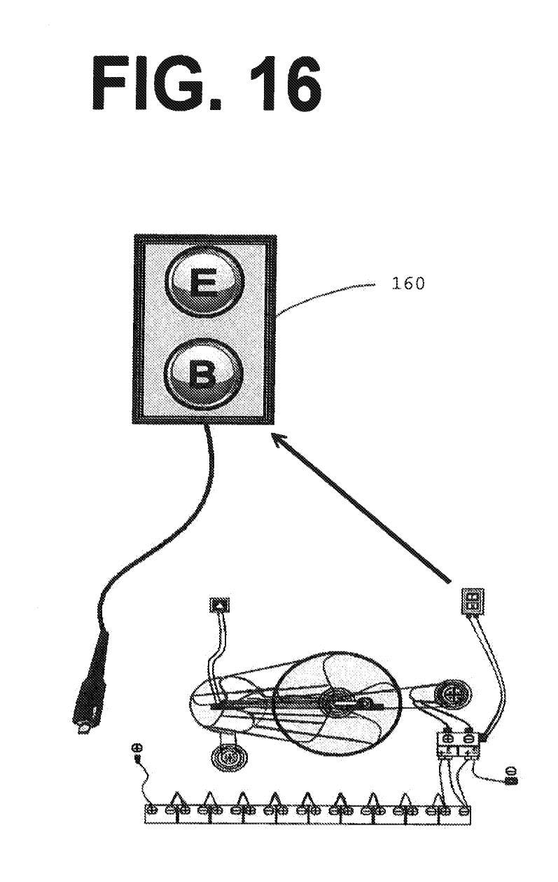

FIG. 16 is a closer view of an exemplary control panel, panel 160, that may be used to change the performance of the presently disclosed subject matter from economy (“E” or ECO) to Boost (“B”), as described in FIG. 15 above.

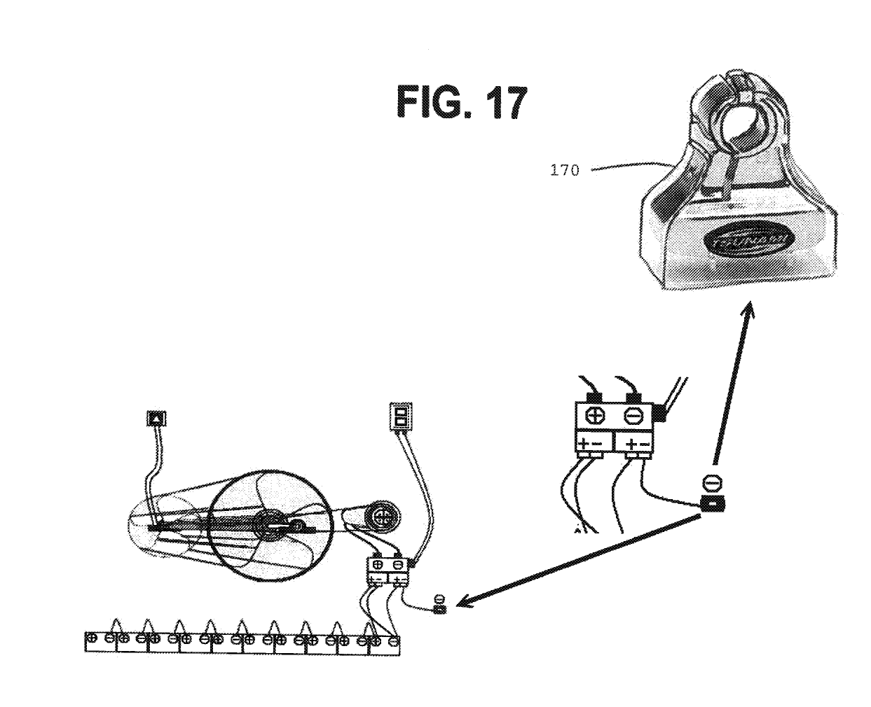

FIG. 17 is a picture of an exemplary ground that may be used to electrically ground the system.

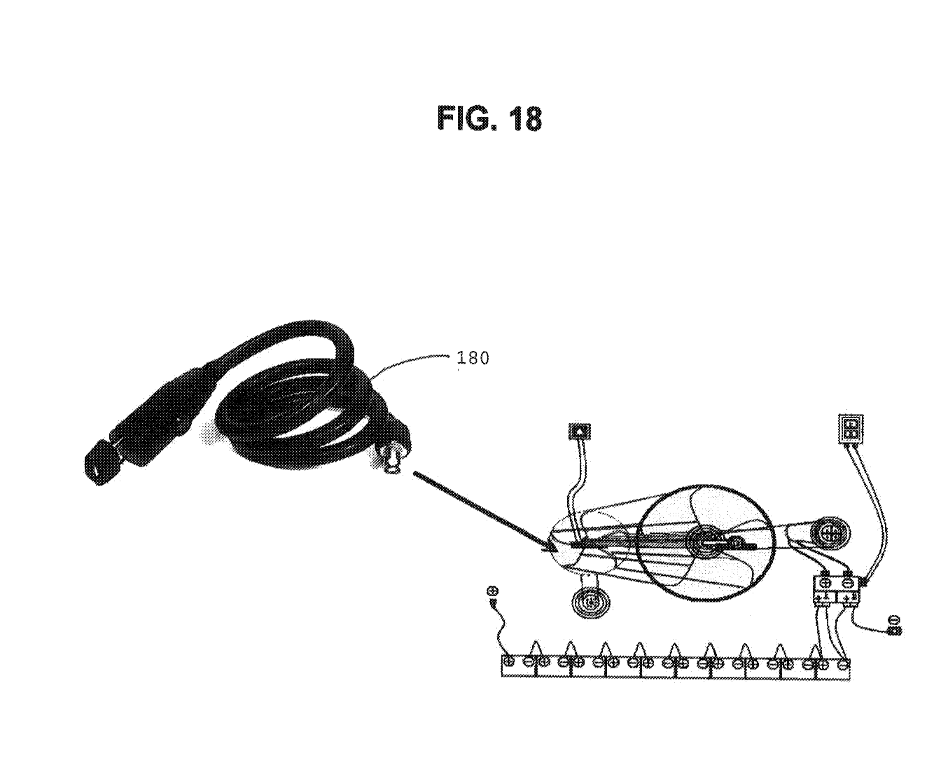

If a paddle assembly needs to be locked, such as following a malfunction or for general stowage, locking cable 180 of FIG. 18 is an exemplary means by which to lock a paddle assembly. A warning indicator, such as indicator 700 of FIG. 7, may be used to inform a user that the paddle assembly needs to be locked to prevent rotation.

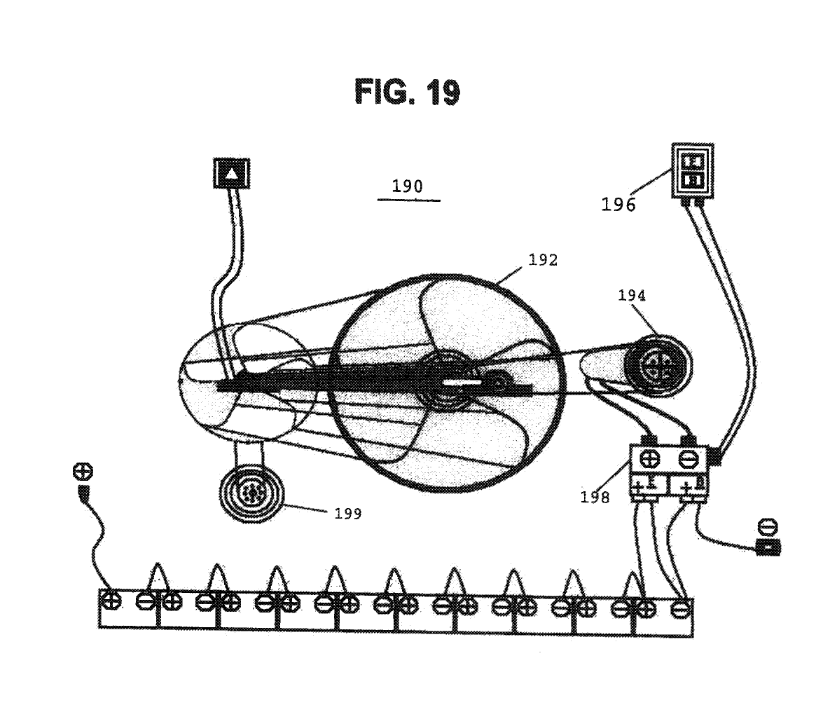

FIG. 19 shows an exemplary configuration 190 of the presently disclosed subject matter. Shown are paddle assembly 192, generator 194, control panel 198 and manual control 196. As paddle assembly 192 rotates, the rotational motion may be transferred directly to a generator (shown as generator 194). Generator 194 may also be a starter motor, or igniter. Additionally, a generator may be connected to system 190 through the use of gear assembly 199. Control panel 198 may be used to control the generation or distribution of electrical power.

It will be apparent to those of ordinary skill in the art that the subject matter of the present invention can be appropriately scaled, to increase or decrease the relevant characteristics described hereinabove, and the subject matter utilized with any form of electrically powered vehicle, including, without limitation, automobiles, trucks, railway engines, boats, or the like.

While the embodiments have been described in connection with the preferred embodiments of the various figures, it is to be understood that other similar embodiments may be used or modifications and additions may be made to the described embodiment for performing the same function without deviating therefrom. Therefore, the disclosed embodiments should not be limited to any single embodiment but rather should be construed in breadth and scope in accordance with the appended claims.

What is claimed:

1. An electrical power system for a vehicle comprising:
a paddle assembly positioned within a vehicle and comprising a least one fan blade; and
a generator in mechanical communication with said paddle assembly, wherein rotation of the paddle assembly caused by directed air flow from motion of the vehicle imparting a rotational motion on the paddle assembly is translated to rotational motion of the generator.

2. The system of claim 1 wherein said generator produces electrical energy for use by the vehicle.

3. The system of claim 2 wherein said electrical energy is routed to a battery associated with the vehicle for recharging said battery.

4. The system of claim 2 wherein said electrical energy is routed for direct use in powering a propulsion system of the vehicle.

5. The system of claim 1 wherein an axis of rotation of said paddle assembly is disposed horizontally in the vehicle, and transverse to a primary direction of airflow.

6. The system of claim 1 wherein mechanical communication is provided by gearing.

7. The system of claim 1 wherein mechanical communication is provided by a chain linkage.

8. The system of claim 1 wherein mechanical communication is provided by a cable assembly.

9. The system of claim 1 wherein mechanical communication is provided by a substantially continuously variable transmission.

10. The system of claim 1 wherein the paddle assembly is initially rotated to a predetermined speed prior to engagement with the generator.

11. The system of claim 1 further comprising a flywheel in mechanical association therewith.

12. The system of claim 1 further comprising one or more means for monitoring said system.

13. The system of claim 1 wherein said paddle assembly may be locked in a non-rotating configuration.

14. The system of claim 1 further comprising an electronic control system.

15. The system of claim 14 wherein said electronic control system may be configured to place said system in a plurality of electrical distribution modes.

16. The system of claim 15 wherein said electronic control system may be configured to place said system in an economy mode, wherein the output of said generator may be provided to the vehicle's electrical system in a parallel electrical configuration.

17. The system of claim 15 wherein said electronic control system may be configured to place said system in a boost mode, wherein the output of said generator may be provided to the vehicle's electrical system in a series electrical configuration.

18. An electrical power system for a vehicle comprising a paddle assembly positioned within a vehicle and comprising a plurality of fan blades, wherein an axis of rotation of said paddle assembly is disposed horizontally in the vehicle and transverse to a primary direction of airflow; a generator in mechanical communication with said paddle assembly, wherein rotation of the paddle assembly caused by directed air flow from motion of the vehicle imparting a rotational motion on the paddle assembly is translated to rotational motion of the generator; an electronic control system, wherein said electronic control system is configurable to place said system in a first economy mode, wherein the output of said generator may be provided to the vehicle's electrical system in a parallel electrical configuration, and, alternatively, in a second boost mode, wherein the output of said generator may be provided to the vehicle's electrical system in a series electrical configuration.

19. The system of claim 18, further comprising one or more means for monitoring said system.

20. A vehicle comprising an electrical power system, said electrical power system comprising a paddle assembly positioned within a vehicle and comprising a plurality of fan blades, wherein an axis of rotation of said paddle assembly is disposed horizontally in the vehicle and transverse to a primary direction of airflow; a generator in mechanical communication with said paddle assembly, wherein rotation of the paddle assembly caused by directed air flow from motion of the vehicle imparting a rotational motion on the paddle assembly is translated to rotational motion of the generator; an electronic control system, wherein said electronic control system is configurable to place said system in a first economy mode, wherein the output of said generator may be provided to the vehicle's electrical system in a parallel electrical configuration, and, alternatively, in a second boost mode, wherein the output of said generator may be provided to the vehicle's electrical system in a series electrical configuration.
